(19) United States
(12) Patent Application Publication
(10) Pub. No.: US 2011/0233824 A1
(43) Pub. Date: Sep. 29, 2011

(54) METHOD OF MOLDING A HOLLOW BODY OF REVOLUTION

(75) Inventors: Michel ALATERRE, Breteuil Sur Iton (FR); Mickaël BAILLIE, Sotteville Les Rouen (FR)

(73) Assignee: VALOIS SAS, Le Neubourg (FR)

(21) Appl. No.: 13/072,459

(22) Filed: Mar. 25, 2011

(30) Foreign Application Priority Data
Mar. 25, 2010 (FR) 10 52157

(51) Int. Cl. B29C 45/18; G01F 11/00

(52) U.S. Cl. 264/328.12; 16/2.1; 222/256

(57) ABSTRACT

A method of molding by injecting plastics material into a mold to make a part that is symmetrical about an axis of revolution, the part being hollow with a through passage along the axis, the part having two axial ends each defining an annular opening, the method comprising injecting the plastics material into the mold via an annular opening in an axial end of the part along an annular injection line, the plastics material containing solid particles of the flake or pearlescent type, thereby imparting flake and/or pearlescent highlights to the molded part.

### FIELD OF THE INVENTION

The present invention relates to a method of injection molding molten plastics material into a mold in order to make a part that is hollow with a through passage. Preferably, the part is symmetrical about an axis of revolution so as to define two axial ends, each defining an axial opening. Such parts may be used in numerous technical fields, and more particularly in the fields of cosmetics, perfumery, or indeed pharmacy, being in the form of a reservoir, a fastener ring, a decorative bushing, or a pusher and a protective cap.

### BACKGROUND OF THE INVENTION

In conventional manner, parts are made by injection-molding plastics material into a mold that forms a mold cavity for filling with the molten plastics material. The mold cavity is fed with plastics material via an injection point that, by definition, presents a spot of very small size. The injection point defines the point where the molding is separated from the injection pipe on leaving the mold, and as a result it is often visible. The object is to make the injection point at a location and of a size such that it is not visible, or practically not visible, to the final user. The molten plastics material thus penetrates into the molding cavity via the injection point and propagates inside the cavity in a manner that depends on its shape. Very often, the molten plastics material propagates in the form of sheets in two opposite or transverse directions, thereby creating a junction or weld line where the molten plastics material of one sheet joins the material of the other. The junction or weld line is often visible to the final user, and spoils the appearance of the part. This is true for most plastics materials, but is even more true for plastics materials that contain solid particles of the flake or pearlescent type that impart flake and/or pearlescent highlights to the molded part. The solid particles flow in the liquid stream of molten plastics material, but they tend to accumulate in certain locations, and more particularly along the junction line between two sheets. The solid particles become concentrated along the junction line and at the injection point, which thus become directly visible and make the user feel that there is a molding defect, thereby harming the quality image of the part.

### OBJECT AND SUMMARY OF THE INVENTION

An object of the present invention is to remedy the above-mentioned drawbacks of the prior art by defining a method of injection molding a plastics material, which method serves to avoid forming a visible junction or weld line in the molded part. The molding method of the invention is particularly applicable for use with plastics materials containing pearlescent or flake particles.

For this purpose, the method of the present invention comprises injecting molten plastics material into the mold via an annular opening in one end of the part along an annular injection line. The injected plastics material contains solid particles having reflective facets. These solid particles may be of the flake or pearlescent type conferring pearlescent and/or flake highlights to the molded part.

In other words, the molten plastics material is injected into the molding cavity, not via an injection point, but via a longer zone that is in the form of a loop line and that is situated at an opening in an end of the part, which part presents symmetry of revolution about an axis. With the molding method of the invention, it is possible to make any part that presents symmetry of revolution, even if only locally, and that includes an annular opening. The simplest part is in the form of a hollow tube. Any cylindrical or conical shape or any combination of such shapes may be made using the method of the invention. Injecting along an annular line serves to avoid forming a junction line in the molded part, given that the molten plastics material spreads inside the molding cavity in a single sheet that moves symmetrically at substantially constant speed along the axis of symmetry or of revolution. The sheet thus spreads inside the cavity all the way to the opposite end of the part. No junction line can therefore be formed.

Just like an injection point, the injection line likewise defines a break or rupture line when the part leaves the mold.

Preferably, the part is symmetrical about an axis of revolution (X) so as to define two axial ends.

Advantageously, the annular injection line is centered on the axis of revolution. It is thus easy to feed the molten plastics material symmetrically via the annular injection line.

In a practical embodiment, the plastics material may be conveyed to the annular injection line via an injection chamber having its outer periphery in contact with the annular injection line. Advantageously, the injection chamber is symmetrical about the axis of revolution. Preferably, the injection chamber includes an injection point situated on the axis of revolution. The axial location of the injection point enables the injection chamber to be filled symmetrically with the molten plastics material then propagating radially like a wave. Thus, the annular injection line is fed uniformly over its entire length. The molten plastics material can subsequently propagate inside the mold cavity in the form of a single tubular sheet.

In another implementation, the method may include moving a closure pin in an injection channel so as to define a passage for plastics material between the channel and the pin, the channel being annular and defining the annular injection line. Advantageously, the pin forms the annular opening in the axial end of the part where the annular injection line is situated. The closure pin may thus perform two functions, namely that of a member for closing the end of the injection channel, and that of forming the annular opening at the axial end. These two functions are implemented merely by moving the closure pin in the injection channel. By way of example, the pin may include an enlarged pin head that may be retracted into the injection channel in order to close the channel, and that may be extended from the channel in order to create the passage for plastics material that defines the annular injection line and the annular opening at the axial end. Thus, when in the extended position, the pin head performs two functions.

The present invention also defines a plurality of parts molded using the molding method of the invention, these parts being component parts for a fluid dispenser, such as a decorative bushing, a fastener ring, a protective cap, a fluid dispenser head, or a reservoir, e.g. constituting a sliding cylinder containing a follower piston. Under such circumstances, the annular opening of the reservoir also forms a vent hole that allows the follower piston to be subjected to atmospheric pressure.

The core of the present invention lies in injecting the molten plastics material (containing solid particles that have reflective facets) along an annular injection line, thereby enabling the molten plastics material to propagate inside the mold without forming a junction or weld line.

### BRIEF DESCRIPTION OF THE DRAWINGS

The invention is described in greater detail below with reference to the accompanying drawings showing several embodiments of the invention by way of non-limiting example.

In the figures:

FIG. 1 is a vertical cross-section view through a fluid dispenser incorporating a plurality of parts made by the molding method of the invention;

FIG. 2 is a view similar to FIG. 1 for another fluid dispenser, likewise incorporating parts made by the molding method of the invention;

FIG. 3 is a vertical cross-section view on a larger scale of a decorative bushing for a fluid dispenser showing an implementation of the molding method of the invention; and

FIGS. 4 and 5 are cross-section views showing a second implementation of the invention enabling a reservoir to be molded in the form of a sliding cylinder for a follower piston.

### MORE DETAILED DESCRIPTION

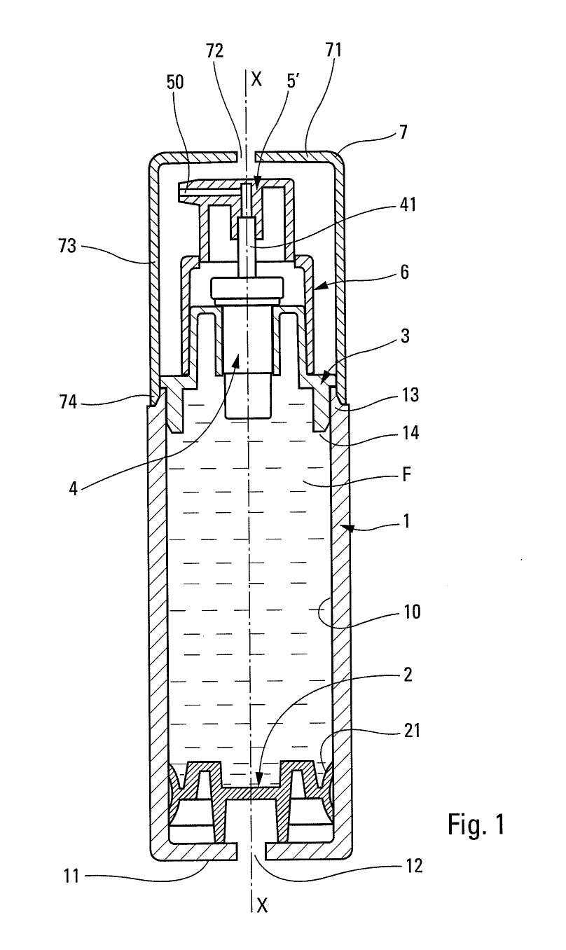

Reference is made initially to FIG. 1 while describing in detail a fluid dispenser incorporating component parts molded by the method of the invention. The dispenser presents an overall configuration that is generally symmetrical about an axis of revolution X. The dispenser comprises a reservoir 1 with a bottom 11 having a vent hole 12. On the inside, the reservoir 1 defines a sliding cylinder 10 of circularly cylindrical shape. The reservoir 1 contains a follower piston 2 having one or two sealing lips 21 for sliding in leaktight manner inside the cylinder 10. The fluid F is situated inside the cylinder 10 above the follower piston 2, which piston communicates with the outside air through the vent hole 12 such that it is constantly subjected to atmospheric pressure on its bottom face. It may be observed that the vent hole 12 is situated on the longitudinal axis of symmetry X of the dispenser. At its top end, the reservoir has a neck 13 defining an opening 14. The fluid reservoir 1 is a symmetrical hollow part forming a body of revolution about the axis X of the dispenser. The cylinder 10 is perfectly tubular and the bottom end formed by the bottom 11 is pierced by the vent hole 12 that is situated on the axis X. The follower piston 2 is also a symmetrical body of revolution.

The dispenser also includes a fastener ring 3 that is engaged in fixed and leaktight manner inside the neck 13, thereby closing the opening 14. The fastener ring 3 is a hollow part constituting a body of revolution and made of plastics material. It defines two open ends that form a through passage. The fastener ring 3 receives a pump having its inlet communicating directly with the inside of the reservoir 1. At its opposite end, the pump 4 forms a valve rod 41 that is movable axially backwards and forwards against a return spring (not shown). A pusher 5′ is mounted on the actuator rod 41 and includes a dispenser orifice 50. The user can thus press on the pusher 5′ in order to actuate the pump, thereby dispensing doses of fluid taken from the reservoir 1. Furthermore, the fastener ring 3 is surrounded by a decorative bushing 6 that performs an appearance function in this example. In certain circumstances, the decorative ring 6 may also perform a technical function, for example the function of blocking the fastener ring 3 on or in the neck of the reservoir. Just like the fastener ring 3 and the reservoir 1, the decorative bushing 6 is a part forming a hollow body of revolution about the axis X. It has two open ends defining a through passage. Optionally, the dispenser has a protective cap 7 that is mounted on the reservoir 1 and/or on the fastener ring 3. The protective cap 7 masks the pusher 5′ and the decorative bushing 6. The protective cap 7 defines a substantially cylindrical skirt 73 having its bottom end 74 engaged on the reservoir 1 and/or the fastener ring 3. At its top end, the skirt 73 is closed by an end wall 71 that includes a central axial ventilation hole 72. Thus, the protective cap is likewise in the form of a body of revolution about the axis X. That design for a fluid dispenser is entirely conventional in the fields of cosmetics, perfumery, or indeed pharmacy.

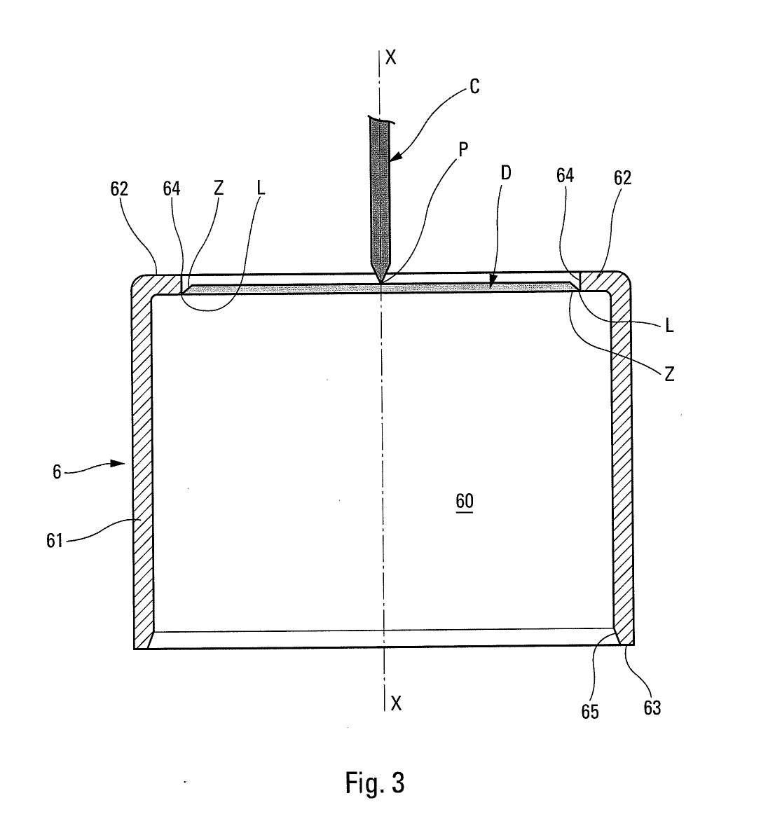

It may be observed that several of the component parts of the dispenser, specifically the reservoir 1, the fastener ring 3, the decorative bushing 6, and the protective cap 7 are hollow bodies of revolution having two opposite open ends so as to form respective through passages. Each opposite end defines an annular opening. According to the invention, these parts may be made by a method of molding by injecting molten plastics material, which method comprises injecting the molten plastics material into the mold via an annular opening at an axial end of the part along an annular injection line. With reference to the reservoir 1, the annular injection line may be situated at the opening 14 of the neck 13 or at the vent hole 12 in the bottom 11. More precisely, the injection line may be defined at the inner edge defining the opening 14 or 12. With reference to the protective cap 7, the annular injection line is defined at the ventilation hole 72 or at the bottom end 74. The same applies to the fastener ring 3. As for the decorative bushing 6, its molding is described in greater detail below with reference to FIG. 3.

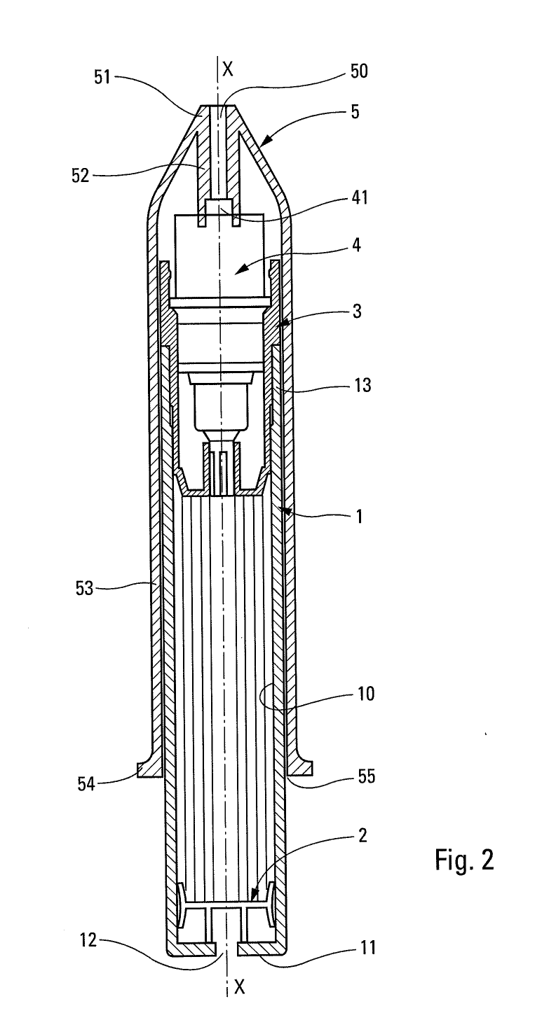

Reference is now made to FIG. 2 to describe in detail a second dispenser having certain component parts made with the molding method of the invention. The fluid dispenser comprises a fluid reservoir 1 having a bottom 11 provided with a central vent hole 12, and also comprising a neck 13. On the inside, the reservoir 1 forms a sliding cylinder 10 for a follower piston 2. The reservoir in FIG. 2 is substantially similar to or identical with that of FIG. 1. It constitutes a body of revolution about the axis X. The dispenser also includes a fastener ring 3 that is engaged in fixed and leaktight manner inside the opening 13 of the reservoir 1. The fastener ring is a hollow body of revolution about the axis X. The fastener ring 3 receives a pump 4 having an inlet communicating with the reservoir 1 and an actuator rod 41 that is axially movable, backwards and forwards. The valve rod 41 is covered by a dispenser head 5 that presents a special design. This dispenser head 5 includes not only a dispenser orifice 50 formed at the top end 51 of a duct 52, but also a cover 53 that surrounds the fastener ring 3 and a portion of the reservoir 1. The bottom end 54 of the cover 53 projects outwards so as to be suitable for being gripped by a user's fingers. This end 54 defines an annular opening 55. In order to actuate the dispenser, the user takes hold of the bottom end 54 between the index and middle fingers and presses against the bottom 11 with the thumb. This dispenser is thus handled like a syringe.

It may be observed that several of the component parts of the dispenser constitute bodies of revolution with two opposite ends defining annular openings and with respective hollow insides forming passages connecting together the two annular openings. This applies to the reservoir 1, the fastener ring 3, and the dispenser head 5. According to the invention, these parts may be made using the molding method that consists in injecting plastics material into the mold at an annular opening in one of the axial ends of these parts along an annular injection line. By way of example, the line may be situated at the vent hole 12 for the reservoir 1 and at the dispenser orifice 50 for the dispenser head 5. The same applies to the fastener ring 3, e.g. at its top end.

Reference is now made to FIG. 3 to describe in detail an implementation of the molding method of the invention as applied to the decorative bushing 6 of FIG. 1. Naturally, the decorative bushing 6 could be replaced by any other part forming a body of revolution in the dispensers of FIGS. 1 and 2. The decorative bushing 6 has a cylindrical segment 61 defining a top end in the form of a re-entrant flap so as to define a narrow top annular opening 64. The cylindrical segment 61 also defines a bottom end 63 forming a bottom annular opening 65. The two openings 64 and 65 communicate via a hollow inside 60. It is also possible to define the shape of the decorative bushing 6 as a cylindrical tube having its top end folded inwards. According to the invention, the decorative bushing 6 may be molded by injecting molten plastics material via an annular injection line L situated at the opening 64 or 65. In FIG. 3, the injection line L is situated at the top annular opening 64. More precisely, the line L is situated on the inside bottom edge of the top annular opening 64. The annular injection line extends all around the inside periphery of the opening 64. It is also possible to define the annular injection line L at the top edge of the opening 64.

In order to create this annular injection line L, the molding method of the invention provides for delivering molten plastics material to the annular injection line via an injection chamber D whose outer periphery Z is in contact with the annular injection line L. It may even be observed in FIG. 3 that the outer periphery Z narrows going towards the injection line L so as to define a narrowing that serves to provide the opening 64 with a break that is sharp and clean. In the embodiment of FIG. 3, the injection chamber D presents a plane configuration in the form of a disk. In a variant, it is possible for the injection chamber D to present a shape that is conical or dome-shaped. Advantageously, the injection chamber D is symmetrical about the axis X. The injection chamber D is fed from an injection point P that is advantageously situated on the axis X. In FIG. 3, it can be seen that an injection pipe C situated on the axis X feeds the chamber D via an injection point P of very small section. Thus, the molten plastics material coming from the injection pipe C penetrates into the injection chamber D via the central axial injection point P and propagates radially and uniformly inside the chamber D so as to reach simultaneously all points along the annular injection line L situated at the periphery of the chamber. In this way, the molten plastics material propagates inside the molding cavity for the decorative bushing 6 in a manner that is uniform, regular, and symmetrical, without creating any junction line. The molten plastics material will reach all points along the bottom end 63 of the bushing 6 simultaneously. When the plastics material contains solid particles such as flakes or pearlescent particles, that guarantees that these particles are distributed in completely uniform manner over all of the decorative bushing 6. There is thus no non-symmetrical zone presenting a concentration of particles.

The bushing is extracted from the mold by separating the bushing from the injection chamber D at the injection line L, which line thus defines the break or rupture line.

The implementation of the molding method of the invention as described above with reference to the decorative bushing 6 is equally applicable without modification or adaptation to molding the reservoir 1, the fastener ring 3, the dispenser head 5, or the protective cap 7.

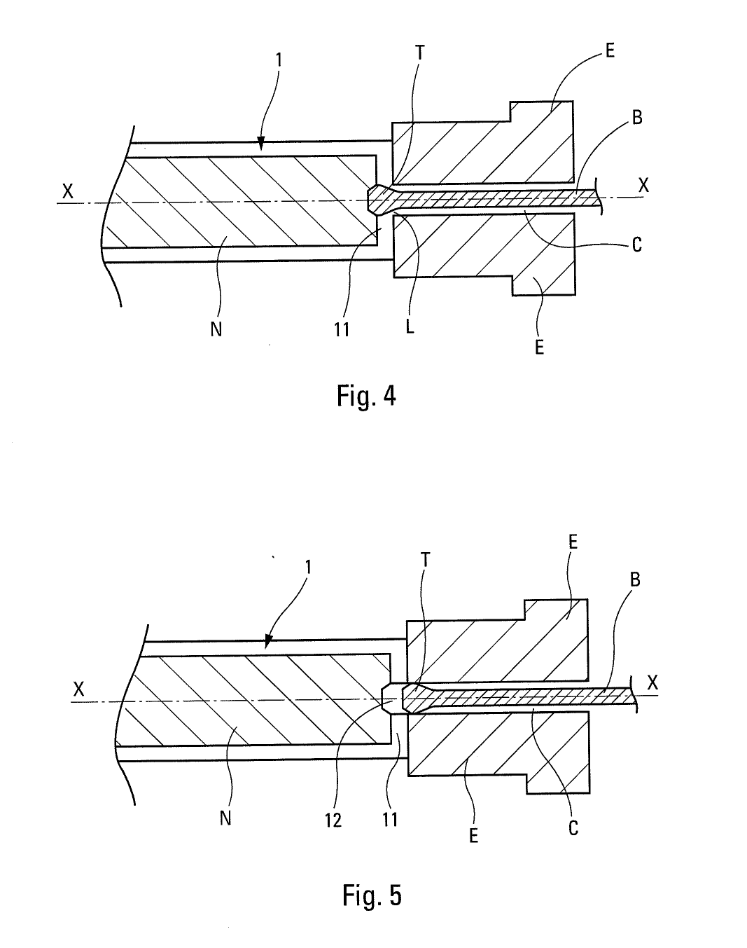

With reference to FIGS. 4 and 5, there follows a description of a second implementation of the molding method of the invention. Reference is made here to a reservoir 1, however this second implementation is equally applicable without difficulty to the other component parts of the dispensers of FIGS. 1 and 2 that constitute bodies of revolution with two annular openings. The reservoir 1 is shown in part only, i.e. in the vicinity of its bottom end or bottom 11. In order to mold the inside of the reservoir, a molding core N is used that is subsequently extracted axially. In order to mold the outside of the bottom 11, an external imprint E is used that defines a central axial injection channel C that extends along the axis of revolution X. The injection channel C contains a closure pin B that is movable axially inside the channel. The pin B has a closure and molding head T presenting a section that is enlarged and that corresponds substantially to the section of the channel C. Thus, the head T may close the channel C in the retracted position, as shown in FIG. 5. The molten fluid inside the channel C can thus find no outlet passage. By moving the closure pin B so as to extract the head T from the channel C, an annular outlet passage is defined for the fluid around the head of the pin. According to the invention, this annular passage defines the annular injection line L, as shown in FIG. 4. Simultaneously, the head T comes into contact with the core N and thus forms the vent hole 12 as can be seen in FIG. 5. The closure pin B thus performs two functions, i.e. that of closing the injection channel C, and that of forming the vent hole 12. When the pin B is extended out from the channel C, its head forms a passage for the molten fluid that extends in the form of an annular line. This implementation of the molding method of the invention may also be applied to the other parts of the dispensers of FIGS. 1 and 2. It should be observed that this second implementation does not generate any loss of plastics material, since the head T of the pin B cuts off the feed directly at the edge of the vent hole 12, i.e. at the annular injection line L.

Although the present invention is described above with reference to parts forming bodies of revolution, the molding method of the invention may be applied to parts that are not bodies of revolution, and even to parts that are not symmetrical. By controlling or balancing the molding parts of volumes in the injection chamber D it is possible to ensure that the molten plastics material reaches all of the locations around the injection line L at the same time. Naturally, such an implementation is more complicated than for molding a body of revolution.

By means of the molding method of the invention, it is possible to make a variety of parts, and in particular component parts for fluid dispensers, while avoiding the formation of any unattractive junction line. The injected plastics material contains solid particles having reflective facets. These solid particles may be of the flake or pearlescent type, imparting flake and/or pearlescent highlights to the molded part.

What is claimed is:

1. A method of molding by injecting plastics material into a mold in order to make a part that is hollow with a through passage, the part having two ends, each defining an annular opening, the method comprising injecting the plastics material into the mold via an annular opening at one end of the part along an annular injection line, the plastics material containing solid particles that include reflective facets, of the flake or pearlescent type, thereby imparting flake and/or pearlescent highlights to the molded part.

2. A molding method according to claim 1, wherein the part is symmetrical about an axis of revolution so as to define two axial ends.

3. A molding method according to claim 2, wherein the annular injection line is centered on the axis of revolution.

4. A molding method according to claim 1, wherein the plastics material is conveyed to the annular injection line via an injection chamber having its outer periphery in contact with the annular injection line.

5. A molding method according to claim 2, wherein the plastics material is conveyed to the annular injection line via an injection chamber having its outer periphery in contact with the annular injection line, and wherein the injection chamber is symmetrical about the axis of revolution.

6. A molding method according to claim 4, wherein the injection chamber includes an injection point situated on the axis of revolution.

7. A molding method according to claim 1, including moving a closure pin in an injection channel so as to define a passage for plastics material between the channel and the pin, the channel being annular and defining the annular injection line.

8. A molding method according to claim 7, wherein the pin forms the annular opening in the axial end of the part where the annular injection line is situated.

9. A part molded in accordance with claim 1, the part constituting a decorative bushing for a fluid dispenser.

10. A part molded in accordance with claim 1, the part consisting in a fluid reservoir of a fluid dispenser.

11. A molded part according to claim 10, wherein the reservoir comprises a sliding cylinder, together with a follower piston slidable in the channel, the opening of the reservoir forming a vent hole.

12. A part molded in accordance with claim 1, the part consisting in a fluid dispenser head of a fluid dispenser.
